(19) United States
(12) Patent Application Publication
(10) Pub. No.: US 2026/0162681 A1
(43) Pub. Date: Jun. 11, 2026

(54) METHOD, APPARATUS, DEVICE, STORAGE MEDIUM AND PROGRAM PRODUCT FOR VIDEO GENERATION

(71) Applicants: Beijing Youzhuju Network Technology Co., Ltd., Beijing (CN); Lemon Inc., Grand Cayman (KY)

(72) Inventors: Chunyu LI, Beijing (CN); Chao ZHANG, Beijing (CN); Weikai XU, Los Angeles, CA (US); Jinghui XIE, Beijing (CN); Weiguo FENG, Los Angeles, CA (US)

(21) Appl. No.: 19/322,265

(22) Filed: Sep. 8, 2025

(30) Foreign Application Priority Data
Dec. 11, 2024 (CN) 202411826601.8

(51) Int. Cl. G11B 27/02

(52) U.S. Cl. CPC G11B 27/02

(57) ABSTRACT

Embodiments of the disclosure provide a method, an apparatus, a device, a storage medium and a program product for video generation. A method includes: obtaining a masked video by performing masking for a predetermined area of a target object in a reference video; determining a first video feature representation of the reference video and a second video feature representation of the masked video, respectively; determining an audio feature representation of target audio; and generating, by using a trained video generation model, a target video containing the target object based on at least the first video feature representation, the second video feature representation and the audio feature representation, the target video representing the target object speaking the target audio with a mouth shape matching the target audio.

### CROSS-REFERENCE

The present application claims priority to Chinese Patent Application No. 202411826601.8, filed on Dec. 11, 2024, and entitled “METHOD, APPARATUS, DEVICE, STORAGE MEDIUM AND PROGRAM PRODUCT FOR VIDEO GENERATION”, which is incorporated herein by reference in its entirety.

### FIELD

Example embodiments of the present disclosure generally relate to the field of computers, and in particular, to a method, an apparatus, a device, a storage medium, and a program product for video generation.

### BACKGROUND

With the continuous development of speech-driven video action synchronization technology, this technology has shown extensive potential in application scenarios such as virtual character generation, dubbing, and video conference. As an important branch in the field of speech-driven video generation, the core task of lip synchronization technology is to generate accurate lip movements based on corresponding speech. How to satisfy the temporal consistency between lip movements and target language is a technical challenge that needs to be solved.

### SUMMARY

In a first aspect of the present disclosure, a method for video generation is provided. The method may include: obtaining a masked video by performing masking for a predetermined area of a target object in a reference video; determining a first video feature representation of the reference video and a second video feature representation of the masked video, respectively; determining an audio feature representation of target audio; and generating, by using a trained video generation model, a target video containing the target object based on at least the first video feature representation, the second video feature representation and the audio feature representation, the target video representing the target object speaking the target audio with a mouth shape matching the target audio.

In a second aspect of the present disclosure, an apparatus for video generation is provided. The apparatus may include: a masked video determination module configured to obtain a masked video by performing masking for a predetermined area of a target object in a reference video; a video feature representation determination module configured to determine a first video feature representation of the reference video and a second video feature representation of the masked video, respectively; an audio feature representation determination module configured to determine an audio feature representation of target audio; and a target video generation module configured to generate, by using a trained video generation model, a target video containing the target object based on at least the first video feature representation, the second video feature representation and the audio feature representation, the target video representing the target object speaking the target audio with a mouth shape matching the target audio.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the electronic device to perform the method of the first aspect.

In a fourth aspect of the present disclosure, a computer-readable storage medium is provided. The medium has a computer program stored thereon, the computer program, when executed by a processor, implementing the method of the first aspect.

In a fifth aspect of the present disclosure, a computer program product is provided. The computer program product includes computer-executable instructions, the computer-executable instructions, when executed by a processor, implementing the method of the first aspect.

It should be understood that the content described in this section is neither intended to limit key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages, and aspects of the embodiments of the present disclosure become more apparent with reference to the following detailed description and in conjunction with the drawings. In the drawings, the same or similar reference numerals denote the same or similar elements.

FIG. 1 illustrates a schematic diagram of an example environment in which embodiments of the present disclosure may be implemented.

FIG. 2 illustrates a flowchart of a method for video generation according to some embodiments of the present disclosure.

FIG. 3 illustrates a schematic diagram of an architecture for video generation according to some embodiments of the present disclosure.

FIG. 4 illustrates a schematic diagram of a processing procedure of a video frame in which a target object is tilted according to some embodiments of the present disclosure.

FIG. 5 illustrates an example diagram of a training process of a video generation model according to some embodiments of the present disclosure.

FIG. 6A illustrates a schematic diagram of a process of determining a time synchronization difference according to some embodiments of the present disclosure.

FIG. 6B illustrates a schematic diagram of a training process of a synchronization network according to some embodiments of the present disclosure.

FIG. 7 illustrates a schematic structural block diagram of an apparatus for video generation according to some embodiments of the present disclosure.

FIG. 8 illustrates a block diagram of an electronic device in which one or more embodiments of the present disclosure may be implemented.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for more thorough and complete understanding of the present disclosure. It should be understood that the drawings and the embodiments of the present disclosure are only for illustrative purposes and are not intended to limit the protection scope of the present disclosure.

In the description of embodiments of the present disclosure, the term “include/comprise” and similar terms should be understood as open-ended inclusions, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. The following may include other explicit and implicit definitions.

Herein, unless otherwise specified, the step of performing a step “in response to A” does not mean that the step is performed immediately after “A”, but may include one or more intermediate steps.

It may be understood that the data involved in the technical solution (including but not limited to the data itself, acquisition, use, storage, or deletion of the data) should comply with requirements of corresponding laws, regulations, and related provisions.

It may be understood that before the use of the technical solution disclosed in the embodiments of the present disclosure, the user shall be informed of the type, range of use, use scenarios, etc., of the information involved in the present disclosure in an appropriate manner in accordance with relevant laws and regulations, and the authorization of the user shall be obtained, where the user may include any type of subject of right, such as an individual, an enterprise, or a group.

For example, in response to reception of an active request from the user, prompt information is sent to the user to clearly inform the user that the requested operation will require access to and use of the information of the user, so that the user may independently choose, based on the prompt information, whether to provide the information to software or hardware, such as an electronic device, an application, a server, or a storage medium, that performs the operations of the technical solution of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the information to the electronic device.

It may be understood that the above process of notifying and obtaining user authorization is only illustrative and does not constitute a limitation on the implementations of the present disclosure, and other manners that satisfy the relevant laws and regulations may also be applied in the implementations of the present disclosure.

As used herein, the term “model” may learn a correlation between corresponding inputs and outputs from training data, so that the corresponding outputs may be generated for given inputs after the training is completed. The generation of the model may be based on machine learning techniques. Deep learning is a machine learning algorithm that uses multiple layers of processing units to process inputs and provide corresponding outputs. A neural network model is an example of a model based on deep learning. Herein, the “model” may also be referred to as a “machine learning model”, a “learning model”, a “machine learning network”, or a “learning network”, which are used interchangeably herein.

With the continuous development of speech-driven image generation technology, this technology has shown extensive potential in application scenarios such as virtual character generation, video conference, and intelligent assistants. As an important branch in the field of speech-driven image generation, the core task of lip synchronization technology is to generate accurate lip movements based on corresponding speech, while maintaining the integrity of head posture and individual identity features.

At present, the more mature lip synchronization technologies are mainly divided into methods based on generative adversarial networks (GANs). However, the methods based on generative adversarial networks face some limitations in practical applications, including, for example, unstable training process, mode collapse, and difficulty in scaling to large-scale and diverse datasets.

FIG. 1 illustrates a schematic diagram of an example environment 100 in which embodiments of the present disclosure may be implemented. As shown in FIG. 1, the environment 100 may include an electronic device 110.

In the example environment 100, the electronic device 110 may obtain input information 102. The input information 102 includes at least a reference video 113 of a target object and target audio 114. As an example, the target object may include a human being, an animal, a cartoon character, a virtual character, and the like. The electronic device 110 may generate, based on the reference video 113 of the target object and the target audio 114, a target video 104 in which the target object speaks the target audio 114 with a mouth shape matching the target audio 114. Only one target model 115 is shown in FIG. 1 as an example, and a plurality of different target models 115 may actually be used in collaboration to complete video generation.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a gaming device, or any combination thereof, including the accessories and peripherals of these devices or any combination thereof. In some embodiments, the electronic device 110 may also support any type of user-specific interface (such as “wearable” circuitry, etc.). A server device (not shown) may be various types of computing systems/servers that may provide computing power, including but not limited to mainframes, edge computing nodes, computing devices in cloud environments, and the like. The server device may, for example, provide a backend service for an application of the electronic device 110.

It should be understood that the structures and functions of the elements in the environment 100 are described for illustrative purposes only, without suggesting any limitation to the scope of the present disclosure.

In embodiments of the present disclosure, an improved solution for video generation is proposed. In this solution, an electronic device obtains a masked video by performing masking on a predetermined area of a target object in a reference video. A first video feature representation of the reference video and a second video feature representation of the masked video are determined respectively. An audio feature representation of target audio is determined. A target video including the target object is generated by using a trained video generation model and based on at least the first video feature representation, the second video feature representation, and the audio feature representation, the target video represents the target object speaking the target audio with a mouth shape matching the target audio.

Through the above process, the masked video is generated by performing masking on the predetermined area of the target object in the reference video, so that a specific area (such as the mouth) of the target object may be focused on during the video generation process. This processing manner enables the video generation model to generate the mouth movement of the target object more precisely and avoids interference from irrelevant areas. A close association between audio and video is realized by determining the feature representations of the reference video and the masked video respectively and combining the audio feature representation. The problem of audio-video synchronization in complex scenarios may be effectively solved by extracting video features and audio features and without relying on additional labeled data. Based on these feature representations, the target video is generated by using the video generation model, which ensures that the target object in the target video matches the target audio in mouth shape.

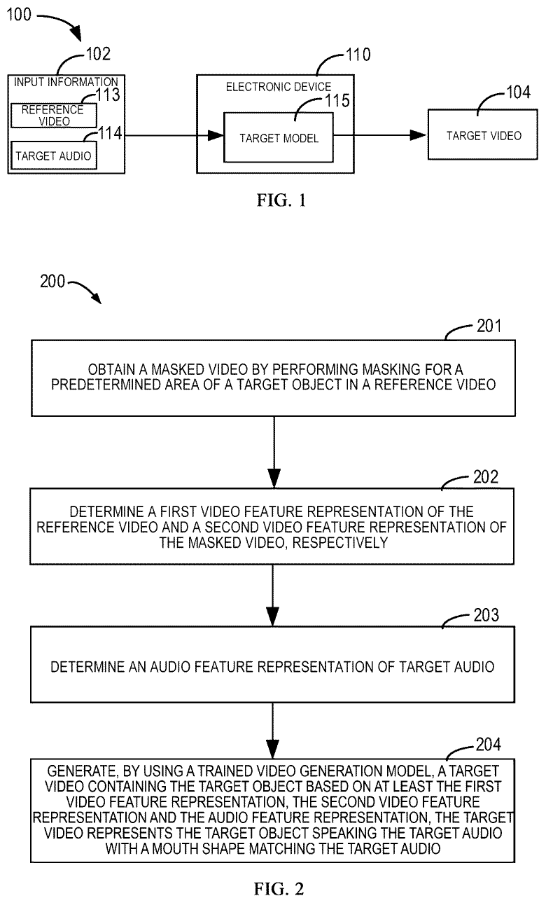

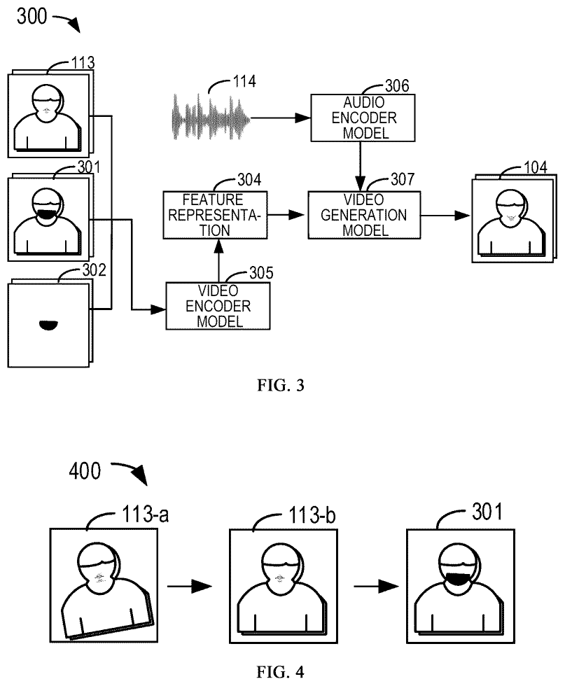

FIG. 2 illustrates an example flow of a method 200 for video generation according to some embodiments of the present disclosure. For ease of discussion, the method 200 will be described with reference to the environment of FIG. 1. In the environment 100, the video generation may be completed by the electronic device 110, but some of the operations may be performed by requesting a server device (not shown) (for example, the determination of the feature representation, the determination of the target video, or the training process of some models may be implemented at the server device). For ease of understanding, the description of the process 200 will be discussed in conjunction with the architecture 300 for video generation of FIG. 3.

At block 201, the electronic device 110 obtains a masked video 301 by performing masking for a predetermined area of a target object in a reference video 113.

The reference video 113 usually includes an activity or behavior performance of the target object. The reference video 113 may be any video including the target object, or a video extracted from other related media (such as a film and television segment, user-generated content, etc.). The target object may be any object that requires image generation. For example, the target object may include a human being, an animal, a cartoon character, a virtual character, and the like.

For the task of generating a target video 104, the target video 104 is generated based on a facial performance (whether speaking or silent) of the target object in the reference video 113, and precise matching between a mouth shape of the target object in the target video 104 and target audio (the target audio is different from speech in the reference video) is achieved. To achieve this goal, it is first necessary to perform masking for the target object in the reference video 113.

The masking may include recognizing and calibrating the predetermined area of the target object in the reference video 113, especially a mouth area or other areas of facial features that need to be generated or adjusted, and masking is performed for the predetermined area to obtain the masked video 301. Masking may be implemented by an image processing algorithm to ensure that the predetermined area may be accurately located and processed in a subsequent generation process. By masking the predetermined area (for example, the mouth area), the model may be caused to pay more attention to information in other areas than the predetermined area from the masked video 301.

At block 202, the electronic device 110 determines a first video feature representation of the reference video 113 and a second video feature representation of the masked video 301, respectively.

In some embodiments, the first video feature representation of the reference video 113 is obtained by performing feature extraction for the reference video 113 by using a trained video encoder model 305, and the second video feature representation of the masked video 301 is obtained by performing feature extraction on the masked video 301 by using the trained video encoder model 305.

In some embodiments, in order to effectively process high-resolution images, the electronic device 110 uses a dimensionality reduction technique to transform high-dimensional data of an original video into a feature representation of lower dimensionality. The video encoder model 305 may use a variational autoencoder (VAE) encoder for feature extraction. The video encoder model 305 may transform the original data of a high-resolution video into a low-dimensional latent variable representation. In this process, the video encoder model 305 may not only effectively compress the facial movements and visual features in the video, but also retain important semantic information. By transforming the visual information of the video into a representation in the latent space, the video encoder model 305 helps reduce the amount of computation, which makes the processing of high-resolution videos more efficient. In addition, the video encoder model 305 may learn an implicit distribution of the data, which allows more efficient generation and interpolation in the latent feature space, and further enhances the quality and consistency of video generation. It should be understood that there may be multiple choices for the model structure and configuration of the video encoder model, which is not limited in the embodiments of the present disclosure.

At block 203, the electronic device 110 determines an audio feature representation of the target audio 114. The target audio 114 may be audio content that is different from the speech in the reference video, for example, may have different content, a different language, etc. In some embodiments, the audio feature representation of the target audio 114 may be obtained by extracting a Mel-spectrogram of the target audio 114 using a trained audio encoder model 306. The Mel-spectrogram is a result of representing the target audio 114 on a Mel frequency scale after short-time Fourier transform processing, which may effectively capture frequency features in the target audio 114 and dynamic information of the frequency features that vary with time. It may be understood that, in addition to the Mel-spectrogram, the audio feature representation of the target audio 114 may also be extracted based on other acoustic information.

At block 204, the electronic device 110 generates a target video 104 including the target object by using a trained video generation model 307 and based on at least the first video feature representation, the second video feature representation, and the audio feature representation, the target video 104 represents the target object speaking the target audio 114 with a mouth shape matching the target audio.

In some embodiments, a feature representation 304 may be obtained by aggregating the first video feature representation of the reference video 113 and the second video feature representation of the masked video 301. The feature representation 304 may include a cascade representation of the two feature representations. The feature representation 304 and the audio feature representation of the target audio 306 are input into the video generation model 307 together.

The video generation model 307 may be constructed based on a diffusion model. As a generative model, the diffusion model generates new data by simulating a forward diffusion process (gradually adding noise) and a reverse diffusion process (gradually removing noise). In the generation process, the diffusion model may start from pure noise and take the input information (here, the video feature representation and the audio feature representation) as a condition to gradually remove noise through a series of steps of reverse denoising to restore the target video content matching the target audio.

Specifically, the video generation model 307 generates the target video 104 synchronized with the target audio 114 through a reverse diffusion process of gradual denoising. Each step of the denoising process is adjusted based on the input features (including the first video feature representation, the second video feature representation, and the audio feature representation) to ensure that the mouth shape of the target object is synchronized with the target audio 114. In this process, each time step corresponds to a gradual transition from noise to real data, which reflects a gradual matching of audio-driven mouth shape generation and the target video. Compared with related video generation methods, the video generation model 307 has the advantage that it may more precisely control the generation details through the reverse diffusion process of multiple time steps, and may stably generate the target video 104 at high resolution. The target video 104 not only ensures mouth synchronization of the target object, but also is more expressive and smooth in terms of details.

Through the above process, the electronic device 110 extracts the feature representations of the reference video 113 and the masked video 301, respectively, and combines them with the audio feature representation of the target audio 114, thereby effectively realizing a close association between audio and video. This manner of feature extraction and fusion enables the generated target video 104 to match the target audio 114 more accurately, ensuring that the target object presents a mouth movement synchronized with the target audio 114 in the target video 114. The diffusion process of the video generation model 307 not only improves the quality of the generated video, but also enhances the temporal consistency and detail expressiveness in the generation process, so that the generated target video 104 is highly consistent in terms of visual and auditory effects.

As shown in FIG. 3, the electronic device 110 performing masking on the predetermined area of the target object in the reference video 113 may include performing masking on the predetermined area of the target object in each video frame of the reference video 113 using a plurality of mask maps 302. Based on this, the electronic device 110 may determine a mask feature representation of the plurality of mask maps 302. The mask feature representation is also input to the video generation model 307 based on the mask feature representation, so that the video generation model 307 generates the target video 104 including the target object. The mask feature representation may be aggregated (for example, by concatenation) to the video feature representations of the reference video 113 and the masked video 301 to form the feature representation 304.

The electronic device 110 may use the mask maps to perform masking on the predetermined area (for example, the mouth area) of the target object in each video frame of the reference video 113. These mask maps not only mark the area that needs to be processed, but also provide precise guidance information indicating the specific area that the video generation model 307 needs to focus on.

Based on the plurality of mask maps 302, the input to the video generation model 307 therefore includes not only the feature representations of the reference video 113, the masked video 301, and the target audio 114, but also the mask feature representation of the mask map 302 corresponding to each frame image of the reference video 113. The mask maps 302 may serve as additional inputs, which facilitates more accurate processing of the predetermined area by the video generation model 307 during the generation process of the target video 104, ensuring that the generated target video 104 may truly reflect the mouth shape and facial expression of the target object.

By introducing the mask maps 302 into the input of the video generation model, the electronic device 110 may rely on these visual instructions to improve the accuracy and consistency of the generation result when generating the target video 104. The above improvement enables the generated target video 104 not only to precisely match the target audio 114, but also to ensure that the facial features of the target object in dynamic change are correctly represented.

FIG. 4 illustrates a schematic diagram of a processing procedure 400 of a video frame in which a target object is tilted according to some embodiments of the present disclosure. As shown in FIG. 4, in some scenarios, the target object in each video frame 113-a of the reference video 113 is tilted. In view of this situation, the electronic device 110 may perform angle transformation on the target object in each video frame of the reference video to obtain a transformed reference video 113-b. Based on this, the electronic device 110 may determine a first video feature representation from the transformed reference video 113-b. Correspondingly, the electronic device 110 may generate an intermediate video based on at least the first video feature representation, a second video feature representation, and an audio feature representation, and perform inverse angle transformation on the target object in respective video frames of the intermediate video to obtain the target video.

The electronic device 110 may perform affine transformation on the target object in each video frame of the reference video 113 to adjust the angle of the target object to a preset standard angle, to obtain the transformed reference video 113-b. As an example, the standard angle may be 0°. If the tilt angle of the target object in the video frame is 0°, the adjustment angle corresponding to the affine transformation is also 0°. If the tilt angle of the target object in the video frame is 5° to the left, the angle corresponding to the affine transformation may be adjusted by 5° to the right.

In this process, the spatial position of the target object is adjusted by the affine transformation to ensure that the angle of the target object in the transformed reference video 113-b is consistent with the preset standard angle, thereby providing a normalized input for the subsequent target video generation process. As an example, during the affine transformation, only the predetermined area (such as the face, the mouth, etc.) of the target object may be transformed to save computing power and improve efficiency.

Based on the transformed reference video 113-b, the electronic device 110 may extract the first video feature representation therefrom, and provide more accurate feature information for the subsequent video generation step. Based on the transformed reference video 113-b, the electronic device 110 performs masking for the predetermined area of the target object in the transformed reference video to obtain the masked video 301. Therefore, the electronic device 110 may use the first video feature representation, the second video feature representation, and the audio feature representation to generate an intermediate video, in which an affine-transformed mouth shape and facial features of the target object match the target audio 114.

After the target video is generated, the electronic device 110 may perform inverse angle transformation on the target object in the intermediate video to adjust the angle of the target object back to the original tilted state, ensuring that the generated target video 104 is consistent in posture with the target object in the original reference video 113. In this process, the affine transformation is applied to restore the target object in the target video 104 to the original video angle, thereby ensuring that the finally generated target video 104 may accurately reflect the audio-synchronized mouth shape and expression, and at the same time maintain the natural appearance and posture of the target object in the video.

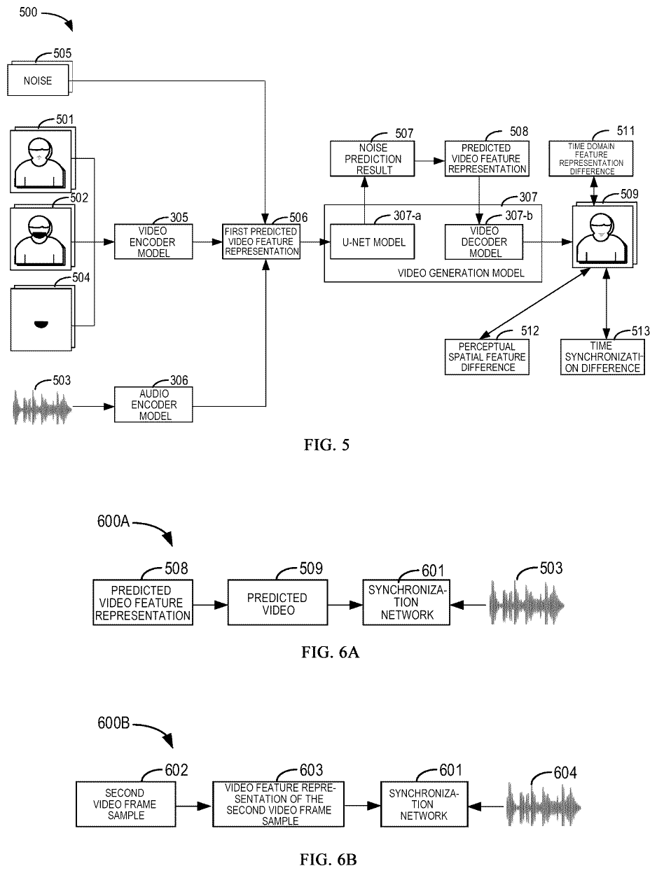

FIG. 5 illustrates a schematic diagram of a training process 500 of a video generation model according to some embodiments of the present disclosure. The training process of the video generation model 307 is described by using an example in which the electronic device 110 performs the training process. A first predicted video feature representation 506 is generated by using a to-be-trained video generation model 307 based on a first training sample, where the first training sample may include a first video sample 501 of a first object sample, a first masked video sample 502, and a first audio sample 503 corresponding to the first video sample 501. The first masked video sample 502 is obtained by performing masking on a predetermined area of the first object sample in the first video sample 501. Based on the first predicted video feature representation 506, the video generation model 307 in the training process (which may also be referred to as a to-be-trained video generation model) may generate a predicted video 509. The electronic device 110 may update the video generation model 307 based on at least a difference between the predicted video 509 and the first video sample 501.

During the training process, the electronic device 110 may perform the training process of the video generation model 307 based on the first training sample. The first training sample includes the first video sample 501 of the first object sample, the first masked video sample 502, and the first audio sample 503 corresponding to the first video sample 501. In addition, the first training sample may further include noise 505 and a plurality of mask map samples 504. The plurality of mask map samples 504 are obtained by performing masking on the predetermined area of the first object sample in each video frame of the first video sample 501. The electronic device 110 may use the to-be-trained video generation model 307 to generate the first predicted video feature representation 506 by inputting the first video sample 501, the first masked video sample 502, the first audio sample 503, the noise 505, and the plurality of mask map samples 504 in the first training sample.

After the first predicted video feature representation 506 is generated, a U-Net model (U-Net) 307-a in the video generation model 307 may generate predicted noises 507. The predicted noises 507 may represent a noise part removed from a current latent variable, and are key information for restoring the generated video. An estimated clean latent 508 may be obtained based on the predicted noises 507. The estimated clean latent 508 obtained may be expressed as follows:

$${\hat{z}}_{0} = ( {z}_{t} - \sqrt{1 - {\overline{α}}_{t}} {ϵ}_{θ} ( {z}_{t} ) ) / \sqrt{{\overline{α}}_{t}} \qquad ( 1 )$$

where \hat{z}₀ may represent the estimated clean latent 508. zₜ may represent the current latent variable, which represents a state after the noise 505 is added through a forward diffusion process. ϵ_{θ}(zₜ) may represent the predicted noises 507. α̅ₜ may represent a signal retention ratio in the diffusion process, and represents an information retention degree of data in the diffusion process.

As an example, the noise 505 may be expressed as follows:

$${ϵ}^{f} = {ϵ}_{s h a r e d} + {ϵ}_{i n d}^{f} \qquad ( 2 )$$

where ϵ_{shared} may represent shared noise, which is global noise and is the same for all video frames. This part of noise ensures global consistency between the video frames.

$${ϵ}_{i n d}^{f}$$

may represent name-specific noise, which is noise specific to each frame. With this part of noise, the model may capture a unique change of each frame without losing global consistency.

The estimated clean latent 508 indicates a latent video feature from which noise is removed. Through this process, the U-Net model 307-a may extract a latent variable representation close to real from the noise prediction. The estimated clean latent 508 is processed by using a video decoder model 307-b in the to-be-trained video generation model 307, and the predicted video 509 may be decoded and generated. Next, the electronic device 110 may compare the difference between the predicted video 509 and the first video sample 501. Based on these differences, the electronic device 110 may update a parameter of the video generation model 307, thereby adjusting the generation effect of the model, and gradually reducing the difference between the predicted video and a real video, to complete the training of the video generation model 307.

As an example, the electronic device 110 updating the parameter of the video generation model 307 may include two stages. The first stage may be comparing the difference between the predicted noises 507 and the noise 505, and updating the parameter of the video generation model 307 based on the difference. Comparing the difference between the predicted noises 507 and the noise 505 may be expressed as follows:

$${ℒ}_{simple} = {𝔼}_{x , A , ϵ ∼ 𝒩 ( 0 , 1 ) , t} [ {‖ ϵ - {ϵ}_{θ} ( {z}_{t} , t , {τ}_{θ} ( A ) ) ‖}_{2}^{2} ] \qquad ( 3 )$$

where [symbol] _{(0,1),t} may represent an expectation operation, which is applied to the video frame x, an audio feature A, the noise ϵ, and the time step t, and is used to calculate an average error of noise prediction. ϵ may represent the noise 505. ϵ_{θ}(zₜ, t, τ_{θ}(A)) may represent the predicted noises 507, zₜ may represent the current latent variable, t may represent the time step, and τ_{θ}(A) may represent a noise feature representation corresponding to the predicted noises 507.

The second stage may include comparing a time domain feature representation difference 511 and a perceptual spatial feature difference 512 between the predicted video 509 and the first video sample 501, and comparing a time synchronization difference 513 between the predicted video 509 and the first audio sample 503. The parameter of the video generation model 307 is updated based on the foregoing differences. The specific comparison process in the second stage will be described in detail later.

By repeatedly performing this process, the video generation model 307 gradually learns, during the training process, how to accurately generate a video output matching the video sample based on the audio features. This process not only enables the video generation model to better understand the synchronization relationship between audio and video, but also optimizes the generation capability of the model, improves the video generation quality, and ensures that the mouth shape of the target object in the target video is synchronized with the target audio.

The training process in the second stage is described below. The electronic device 110 determines the time synchronization difference 513 between the predicted video 509 and the first audio sample 503 by using a trained synchronization network (SyncNet). The video generation model 307 is updated based on the time synchronization difference 513.

FIG. 6A illustrates a schematic diagram of a process 600A of determining a time synchronization difference according to some embodiments of the present disclosure. The synchronization network 601 may be configured to evaluate the synchronization between each video frame of the predicted video 509 and the first audio sample 503. The time synchronization difference 513 between each video frame of the predicted video 509 and the first audio sample 503 is calculated by analyzing feature representations of each video frame of the predicted video 509 and the first audio sample 503. The synchronization evaluation may include determining whether the video frame of the predicted video 509 matches the content of the first audio sample 503 in terms of the mouth shape and the like. The time synchronization difference 513 may be expressed as follows:

$${L}_{s y n c} = {𝔼}_{x , a , ϵ , t} [ SyncNet ( {𝒟 ( {\hat{z}}_{0} )}_{f : f + 16} , {a}_{f : f + 16} ) ] \qquad ( 4 )$$

where [symbol] _{x,a,ϵ,t} may represent an expectation operation, which represents averaging all training sample audio-video pairs (that is, evaluating a video frame x of the predicted video 509, an audio feature a of the first audio sample 503, the noise ϵ, and the time step t) to calculate a time synchronization loss. [symbol] (\hat{z}₀)_{f:f+16} may represent a video frame sequence (f:f+16 may be used as a time window of the frame sequence, usually 16 consecutive frames) of the predicted video 509 (in the pixel dimension) obtained based on the estimated clean latent 508. α_{f:f+16} may represent an audio frame sequence corresponding to the video frame sequence.

According to the determined time synchronization difference 513, the electronic device 110 may update the parameter of the video generation model based on the difference. Through this process, the video generation model 307 may optimize the generation effect, optimize the synchronization between the predicted video 509 and the first audio sample 503, and reduce a temporal error between audio and video. Through continuous feedback and optimization, the video generation model 307 will be gradually improved in each training stage, thereby achieving more precise and natural audio-video synchronization.

Regarding the time synchronization difference 513, the electronic device 110 may further extract a second predicted video feature representation of the predicted video 509. An audio feature representation of the first target audio sample 503 is determined. The trained synchronization network 601 is used to determine the time synchronization difference 513 based on the second predicted video feature representation and the audio feature representation of the first target audio sample 503.

Based on the predicted video 509, the electronic device 110 may determine the second predicted video feature representation corresponding to the predicted video 509. The second predicted video feature representation may be a high-dimensional feature extracted from the predicted video 509, which covers the structure, texture, and other visual information related to synchronization with the target audio of each video frame. In addition, the electronic device 110 may further determine the audio feature representation of the first target audio sample 503, which includes time-frequency features in the first target audio sample 503, especially key information such as the rhythm, tone, and duration of the audio.

After the second predicted video feature representation and the audio feature representation of the first target audio sample 503 are determined, the electronic device 110 may determine the time synchronization difference 513 by using the trained synchronization network 601. In this way, the electronic device 110 may precisely determine the time synchronization difference 513 between the predicted video 509 and the first target audio sample 503, thereby improving the synchronization between the generated target video and the target audio.

The second predicted video feature representation abstracts and compresses the key content of the predicted video 509 (reducing redundant information and noise), which makes the alignment with the audio feature more direct and effective. The feature space may better capture high-level semantic information (such as the mouth shape and facial expression of a person) of the video, which is directly related to audio features (such as pronunciation and intonation), and may provide a more accurate synchronization signal.

The training process of the synchronization network 601 is described below. FIG. 6B illustrates a schematic diagram of a training process 600B of the synchronization network 601 according to some embodiments of the present disclosure. The electronic device 110 determines a time synchronization prediction result between a second video frame sample 602 and a second audio sample 604 using a to-be-trained synchronization network based on a second training sample, where the second training sample includes a video feature representation of the second video frame sample 602 and an audio feature representation of the second audio sample. The synchronization network 601 is trained based on a difference between the time synchronization prediction result and a ground-truth time synchronization result labeled for the second training sample, where the ground-truth time synchronization result indicates an audio-video synchronization degree between the second video frame sample 602 and the second audio sample 604.

The second training sample may include a video feature representation 603 of the second video frame sample that includes a second object, and an audio feature representation of the second audio sample 604. The video feature representation 603 of the second video frame sample includes key visual information in the second video frame sample 602. The audio feature representation of the second audio sample 604 is usually represented as a Mel-spectrogram, which reflects the time-frequency feature of the audio.

The electronic device 110 may use the synchronization network 601 to be trained to determine the time synchronization prediction result between the second video frame sample 602 and the second audio sample 604. The synchronization network 601 to be trained may output a prediction result representing whether the video frame and the corresponding audio are synchronized based on the association between the video frame and the audio feature according to the video feature representation 603 of the input second video frame sample and the audio feature representation of the second audio sample 604.

During the training process, the electronic device 110 may compare the time synchronization prediction result with the ground-truth time synchronization result labeled for the second training sample. The ground-truth time synchronization result represents the actual synchronization degree between the second video frame sample and the second audio sample. By comparing the difference between the prediction result and the labeled result, the electronic device 110 may determine the synchronization loss, and train the synchronization network 601 based on the synchronization loss. The training objective is to minimize the difference between the prediction result and the ground truth, thereby improving the audio-video synchronization accuracy of the synchronization network 601 in future tasks.

In some embodiments of the present disclosure, the electronic device 110 may further determine a first time domain feature representation between a plurality of consecutive video frames in the first video sample 501. A second time domain feature representation between a plurality of consecutive predicted video frames in the predicted video 509 is determined. The electronic device 110 may further update the video generation model 307 based on a difference between the first time domain feature representation and the second time domain feature representation.

The electronic device 110 may determine the first time domain feature representation between the plurality of consecutive video frames in the first video sample 501. These time domain feature representations may indicate a mode of temporal change between the video frames, that is, a temporal relationship of the video. Next, the electronic device 110 may determine the second time domain feature representation among the plurality of consecutive predicted video frames in the predicted video 509, which is used to indicate a temporal relationship between the frames in the generated predicted video 509.

The electronic device 110 may determine the difference between the first time domain feature representation and the second time domain feature representation, and the difference may be used as the time domain feature representation difference 511. The electronic device 110 may enhance the temporal consistency between the video frames by determining the time domain feature representation difference 511, thereby ensuring that the generated video sequence may more accurately reflect the temporal change and avoiding unnatural temporal mismatch in the generated video. The time domain feature representation difference 511 may be expressed as follows:

$${ℒ}_{t r e p a} = {𝔼}_{x , ϵ , t} [ {‖ 𝒯 ( {𝒟 ( {\hat{z}}_{0} )}_{f : f + 16} ) - 𝒯 ( {x}_{f : f + 16} ) ‖}_{2}^{2} ] \qquad ( 5 )$$

where [symbol] _{x,ϵ,t} may represent an expectation operation, which indicates averaging video pairs (the video frame x of the first video sample 501, the noise ϵ, and the time step t) of all training samples to calculate the time synchronization loss. [symbol] ( [symbol] (\hat{z}₀)_{f:f+16}) may represent the second time domain feature representation obtained by performing time domain feature extraction on the video frame sequence (in the pixel dimension) obtained based on the estimated clean latent 508. [symbol] (x_{f:f+16}) may represent the first time domain feature representation obtained by performing time domain feature extraction on the plurality of consecutive video frames of the first video sample 501 corresponding to the video frame sequence.

The electronic device 110 measures the accuracy of the generated video in the temporal dimension by determining the difference between the first time domain feature representation and the second time domain feature representation. The difference determination helps the temporal consistency and visual coherence of the video generation model 307. Through the above process, the video generated by using the trained video generation model 307 not only keeps consistent with the input video in terms of the content of each frame, but also better aligns in the time domain, ultimately achieving a more natural and realistic video generation effect.

In some embodiments of the present disclosure, the electronic device 110 may further select, from the first video sample 501, a target video frame sample temporally corresponding to a predicted video frame in the predicted video 509. A perceptual spatial feature difference 512 between the predicted video frame and the target video frame sample is determined. The electronic device 110 may further update the video generation model 307 based on the perceptual spatial feature difference 512.

For the predicted video frame in the predicted video 509, the electronic device 110 may select, from the first video sample 501, the target video frame sample temporally corresponding to the predicted video frame. Next, the electronic device 110 may determine the perceptual spatial feature difference 512 between the predicted video frame and the target video frame sample. The perceptual spatial feature difference 512 may be expressed as follows:

$${ℒ}_{lpips} = {𝔼}_{x , ϵ , t} [ {‖ {𝒱}_{l} ( {𝒟 ( {\hat{z}}_{0} )}_{f} ) - {𝒱}_{l} ( {x}_{f} ) ‖}_{2}^{2} ] \qquad ( 6 )$$

where [symbol] _{x,ϵ,t} may represent an expectation operation, which indicates averaging video pairs (the video frame x of the first video sample 501, the noise ϵ, and the time step t) of all training samples to calculate the perceptual spatial feature difference. [symbol] ( [symbol] (\hat{z}₀)_{f}) may represent a result of performing feature extraction on the predicted video frame (in the pixel dimension) obtained based on the estimated clean latent 508 by using a trained VGG network. [symbol] (x_{f}) may represent a result of performing feature extraction on the target video frame sample using the trained VGG network.

The electronic device 110 may update the video generation model 307 based on the perceptual spatial feature difference. In this process, by minimizing the difference between the perceptual spatial features, it is ensured that the generated video is closer to the target video in terms of perceptual quality, thereby improving the visual effect and accuracy of the video generation model.

With reference to the foregoing content, the video generation model 307 may be updated based on the difference [symbol] ₛᵢₘₚₗₑ between the predicted noises 507 and the noise 505, the time synchronization difference [symbol] _{sync}, the time domain feature representation difference [symbol] ₜᵣₑₚₐ, and the perceptual spatial feature difference [symbol] ₗₚᵢₚₛ. For each difference, a corresponding weight λ may be configured. Based on this, updating the video generation model 307 may be expressed as follows:

$${ℒ}_{total} = {λ}_{1} {ℒ}_{s i m p l e} + {λ}_{2} {ℒ}_{s y n c} + {λ}_{3} {ℒ}_{lpips} + {λ}_{4} {ℒ}_{t r e p a} \qquad ( 7 )$$

where λ1, λ2, λ3, and λ4 may respectively correspond to different weights.

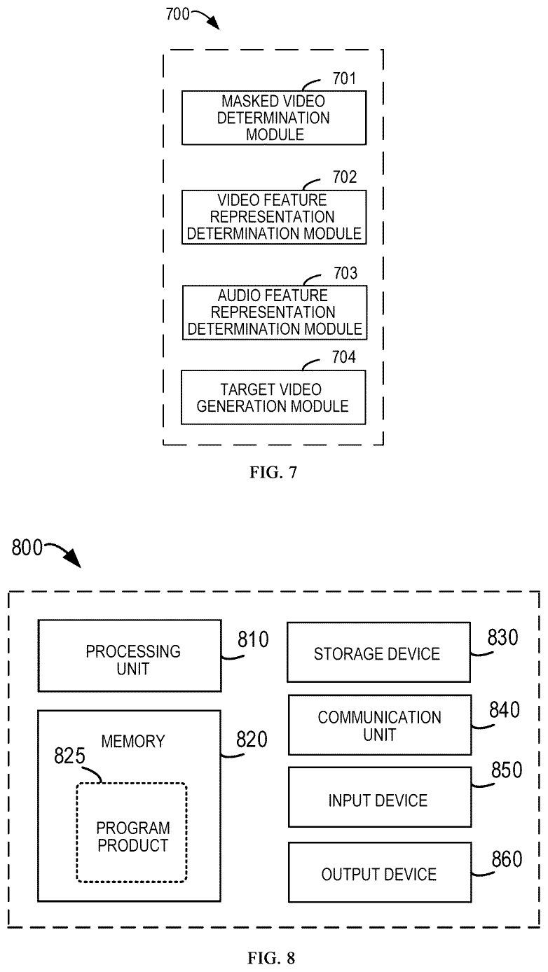

FIG. 7 illustrates a schematic structural block diagram of an apparatus 700 for video generation according to some embodiments of the present disclosure. The apparatus 700 may be, for example, implemented or included in the electronic device 110. Each module/component in the apparatus 700 may be implemented by hardware, software, firmware, or any combination thereof.

As shown in FIG. 7, the apparatus 700 may include a masked video determination module 701 configured to obtain a masked video by performing masking for a predetermined area of a target object in a reference video. A video feature representation determination module 702 is configured to determine a first video feature representation of the reference video and a second video feature representation of the masked video, respectively. An audio feature representation determination module 703 is configured to determine an audio feature representation of target audio. A target video generation module 704 is configured to generate, by using a trained video generation model, a target video containing the target object based on at least the first video feature representation, the second video feature representation and the audio feature representation, the target video representing the target object speaking the target audio with a mouth shape matching the target audio.

In some embodiments of the present disclosure, masking includes performing masking for the predetermined area of the target object in respective video frames of the reference video by using a plurality of mask maps, and the apparatus 700 may further include a feature extraction module. The feature extraction module may be configured to determine a mask feature representation of the plurality of mask maps. The target video generation module 704 may be further configured to generate the target video containing the target object by using the video generation model and further based on the mask feature representation.

In some embodiments of the present disclosure, the feature extraction module may be further configured to perform angle transformation for the target object in respective video frames of the reference video to obtain a transformed reference video. The first video feature representation is determined from a transformed reference video.

In some embodiments of the present disclosure, the target video generation module 704 may be further configured to generate an intermediate video at least based on the first video feature representation, the second video feature representation, and the audio feature representation. Inverse angle transformation is performed for the target object in each video frame of the intermediate video to obtain the target video.

In some embodiments of the present disclosure, the masked video determination module 701 may be further configured to perform masking for the predetermined area of the target object in the transformed reference video to obtain the masked video.

In some embodiments of the present disclosure, the apparatus 700 may further include a model training module. The model training module may be configured to generate a first predicted video feature representation by using a video generation model to be trained and based on a first training sample, the first training sample includes a first video sample of a first object sample, a first masked video sample, and a first audio sample corresponding to the first video sample, and the first masked video sample is obtained by performing masking for a predetermined area of the first object sample in the first video sample; generate a predicted video based on the first predicted video feature representation; and update the video generation model based on at least a difference between the predicted video and the first video sample.

In some embodiments of the present disclosure, the model training module may be configured to determine, by using a trained synchronization network, a time synchronization difference between the predicted video and the first audio sample; and update the video generation model based on the time synchronization difference.

In some embodiments of the present disclosure, the model training module may be configured to extract a second predicted video feature representation of the predicted video; determine an audio feature representation of a first target audio sample; and determine, by using the trained synchronization network, the time synchronization difference based on the second predicted video feature representation and the audio feature representation of the first target audio sample.

In some embodiments of the present disclosure, the model training module may be configured to determine, by using a synchronization network to be trained, a time synchronization prediction result between a second video frame sample and a second audio sample based on a second training sample, the second training sample includes a video feature representation of the second video frame sample and an audio feature representation of the second audio sample; and train the synchronization network based on a difference between the time synchronization prediction result and a ground-truth time synchronization result labeled for the second training sample, the ground-truth time synchronization result indicates an audio-video synchronization degree between the second video frame sample and the second audio sample.

In some embodiments of the present disclosure, the model training module may be configured to determine a first time domain feature representation between a plurality of consecutive video frames in the first video sample; determine a second time domain feature representation between a plurality of consecutive predicted video frames in the predicted video; and update the video generation model further based on a difference between the first time domain feature representation and the second time domain feature representation.

In some embodiments of the present disclosure, the model training module may be configured to select, from the first video sample and for a predicted video frame in the predicted video, a target video frame sample temporally corresponding to the predicted video frame; determine a perceptual spatial feature difference between the predicted video frame and the target video frame sample; and update the video generation model further based on the perceptual spatial feature difference.

In some embodiments of the present disclosure, the predetermined area includes at least a mouth of the target object.

FIG. 8 is a block diagram of an electronic device 800 in which one or more embodiments of the present disclosure may be implemented. It should be understood that the electronic device 800 shown in FIG. 8 is merely illustrative, and should not constitute any limitation on the function and scope of the embodiments described herein. The electronic device 800 shown in FIG. 8 may include or be implemented as the electronic device 110 in FIG. 1 or the apparatus 700 in FIG. 7.

As shown in FIG. 8, the electronic device 800 is in the form of a general-purpose electronic device. The components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor and may perform various processing based on the program stored in the memory 820. In the multi-processor system, a plurality of processing units executes computer-executable instructions in parallel to improve the parallel processing capability of the electronic device 800.

The electronic device 800 typically includes a plurality of computer storage medium. Such medium may be any available medium accessible by the electronic device 800, including, but not limited to, volatile and non-volatile medium, and removable and non-removable medium. The memory 820 may be a volatile memory (for example, a register, cache, or a random access memory (RAM)), a non-volatile memory (such as a read-only memory (ROM), an electrically erasable programmable read-only memory (EEPROM), or a flash memory), or any combination thereof. The storage device 830 may be any removable or non-removable medium, and may include a machine-readable medium such as a flash drive, a disk, or any other medium, which may be used to store information and/or data and may be accessed within the electronic device 800.

The electronic device 800 may further include other removable/non-removable, volatile/non-volatile memory medium. Although not shown in FIG. 8, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 820 may include a computer program product 825 having one or more program modules configured to perform various methods or acts of the various embodiments of the present disclosure.

The communication unit 840 enables communication with other electronic devices through the communication medium. Additionally, the functions of the components of the electronic device 800 may be implemented by a single computing cluster or a plurality of computing machines, which may communicate through communication connections. Therefore, the electronic device 800 may use a logical connection with one or more other servers, a network personal computer (PC) or another network node to operate in a networked environment.

The input device 850 may be one or more input devices, such as a mouse, a keyboard, a tracking ball, etc. The output device 860 may be one or more output devices, such as a display, a speaker, a printer, etc. The electronic device 800 may further communicate with one or more external devices (not shown) such as a storage device and a display device, with one or more devices that enable the user to interact with the electronic device 800, or with any devices (such as a network card and a modem) that enable the electronic device 800 to communicate with one or more other electronic devices through the communication unit 840 as needed. Such communication may be performed via input/output (I/O) interfaces (not shown).

According to an example implementation of the present disclosure, a computer-readable storage medium is provided, on which computer-executable instructions are stored, where the computer-executable instructions are executed by a processor to implement the method described above. According to an example implementation of the present disclosure, there is further provided a computer program product tangibly stored on a non-transitory computer-readable medium and including computer-executable instructions, which are executed by a processor to implement the method described above.

According to an example implementation of the present disclosure, there is provided a computer program product or a computer program including computer instructions stored in a computer-readable storage medium. The processor of the computer device reads the computer instructions from the computer-readable storage medium, and the processor executes the computer instructions, causing the computer device to perform the method provided in various optional implementations in FIG. 2, which will not be repeated here.

Various aspects of the present disclosure are described herein with reference to the flowcharts and/or block diagrams of the method, apparatus, device, and computer program product implemented according to the present disclosure. It should be understood that each block in the flowchart and/or block diagram, and a combination of the blocks in the flowchart and/or block diagram may be implemented by computer-readable program instructions.

These computer-readable program instructions may be provided to the processing unit of a general-purpose computer, a dedicated computer, or other programmable data processing apparatus to produce a machine, such that when the instructions are executed by the processing unit of the computer or other programmable data processing apparatus, an apparatus for implementing the functions/actions specified in one or more blocks in the flowchart and/or block diagram is produced. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/actions specified in one or more blocks in the flowchart and/or block diagram.

The computer-readable program instructions may be loaded onto a computer, another programmable data processing apparatus, or other devices, such that a series of operations and steps are performed on the computer, the other programmable data processing apparatus, or the other devices to produce a computer-implemented process, thereby causing the instructions executed on the computer, the other programmable data processing apparatus, or the other devices to implement the functions/actions specified in one or more blocks in the flowchart and/or block diagram.

The flowcharts and block diagrams in the drawings show the possibly implemented architectures, functions, and operations of the system, the method, and the computer program product according to a plurality of implementations of the present disclosure. In this regard, each block in the flowchart or block diagram may represent a module, program segment, or part of an instruction, which includes one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that performs the specified functions or actions, or may be implemented by a combination of dedicated hardware and computer instructions.

The implementations of the present disclosure have been described above. The foregoing description is illustrative, not exhaustive, and is not intended to limit the disclosed implementations. Many modifications and variations are apparent to those of ordinary skill in the art without departing from the scope and spirit of the described implementations. The terms used herein are selected to best explain the principles of the implementations, the practical applications, or the improvements to the technologies in the market, or to enable other persons of ordinary skill in the art to understand the implementations disclosed herein.

1. A method for video generation, comprising:
obtaining a masked video by performing masking for a predetermined area of a target object in a reference video;
determining a first video feature representation of the reference video and a second video feature representation of the masked video, respectively;
determining an audio feature representation of target audio; and
generating, by using a trained video generation model, a target video containing the target object based on at least the first video feature representation, the second video feature representation and the audio feature representation, the target video representing the target object speaking the target audio with a mouth shape matching the target audio.

2. The method of claim 1, wherein the masking comprises performing masking for the predetermined area of the target object in respective video frames of the reference video by using a plurality of mask maps, the method further comprising:
determining a mask feature representation of the plurality of mask maps; and
wherein generating the target video containing the target object comprises: generating the target video containing the target object by using the video generation model and further based on the mask feature representation.

3. The method of claim 1, wherein determining the first video feature representation of the reference video frame comprises:
performing angle transformation for the target object in respective video frames of the reference video to obtain a transformed reference video; and
determining the first video feature representation from the transformed reference video,
wherein generating the target video comprises:
generating an intermediate video at least based on the first video feature representation, the second video feature representation, and the audio feature representation; and
performing inverse angle transformation for the target object in respective video frames of the intermediate video to obtain the target video.

4. The method of claim 3, wherein obtaining the masked video comprises:
performing masking for the predetermined area of the target object in the transformed reference video to obtain the masked video.

5. The method of claim 1, wherein training of the video generation model comprises:
generating a first predicted video feature representation by using a video generation model to be trained and based on a first training sample, the first training sample comprising a first video sample of a first object sample, a first masked video sample, and a first audio sample corresponding to the first video sample, and the first masked video sample being obtained by performing masking for a predetermined area of the first object sample in the first video sample;
generating a predicted video based on the first predicted video feature representation; and
updating the video generation model based on at least a difference between the predicted video and the first video sample.

6. The method of claim 5, wherein updating the video generation model comprises:
determining, by using a trained synchronization network, a time synchronization difference between the predicted video and the first audio sample; and
updating the video generation model based on the time synchronization difference.

7. The method of claim 6, wherein determining the time synchronization difference between the predicted video and the first audio sample comprises:
extracting a second predicted video feature representation of the predicted video;
determining an audio feature representation of a first target audio sample; and
determining, by using the trained synchronization network, the time synchronization difference based on the second predicted video feature representation and the audio feature representation of the first target audio sample.

8. The method of claim 6, wherein the synchronization network is trained by:
determining, by using a synchronization network to be trained, a time synchronization prediction result between a second video frame sample and a second audio sample based on a second training sample, the second training sample comprising a video feature representation of the second video frame sample and an audio feature representation of the second audio sample; and
training the synchronization network based on a difference between the time synchronization prediction result and a ground-truth time synchronization result labeled for the second training sample, the ground-truth time synchronization result indicating an audio-video synchronization degree between the second video frame sample and the second audio sample.

9. The method of claim 5, wherein updating the video generation model further comprises:
determining a first time domain feature representation among a plurality of consecutive video frames in the first video sample;
determining a second time domain feature representation among a plurality of consecutive predicted video frames in the predicted video; and
updating the video generation model further based on a difference between the first time domain feature representation and the second time domain feature representation.

10. The method of claim 5, wherein updating the video generation model comprises:
selecting, from the first video sample and for a predicted video frame in the predicted video, a target video frame sample temporally corresponding to the predicted video frame;
determining a perceptual spatial feature difference between the predicted video frame and the target video frame sample; and
updating the video generation model further based on the perceptual spatial feature difference.

11. The method of claim 1, wherein the predetermined area comprises at least a mouth of the target object.

12. An electronic device, comprising:
at least one processor; and
at least one memory, the at least one memory being coupled to the at least one processor and storing instructions executable by the at least one processor, the instructions, when executed by the at least one processor, causing the electronic device to perform acts comprising:
obtaining a masked video by performing masking for a predetermined area of a target object in a reference video;
determining a first video feature representation of the reference video and a second video feature representation of the masked video, respectively;
determining an audio feature representation of target audio; and
generating, by using a trained video generation model, a target video containing the target object based on at least the first video feature representation, the second video feature representation and the audio feature representation, the target video representing the target object speaking the target audio with a mouth shape matching the target audio.

13. The electronic device of claim 12, wherein the masking comprises performing masking for the predetermined area of the target object in respective video frames of the reference video by using a plurality of mask maps, the method further comprising:
determining a mask feature representation of the plurality of mask maps; and
wherein generating the target video containing the target object comprises: generating the target video containing the target object by using the video generation model and further based on the mask feature representation.

14. The electronic device of claim 12, wherein determining the first video feature representation of the reference video frame comprises:
performing angle transformation for the target object in respective video frames of the reference video to obtain a transformed reference video; and
determining the first video feature representation from the transformed reference video,
wherein generating the target video comprises:
generating an intermediate video at least based on the first video feature representation, the second video feature representation, and the audio feature representation; and
performing inverse angle transformation for the target object in respective video frames of the intermediate video to obtain the target video.

15. The electronic device of claim 14, wherein obtaining the masked video comprises:
performing masking for the predetermined area of the target object in the transformed reference video to obtain the masked video.

16. The electronic device of claim 12, wherein training of the video generation model comprises:
generating a first predicted video feature representation by using a video generation model to be trained and based on a first training sample, the first training sample comprising a first video sample of a first object sample, a first masked video sample, and a first audio sample corresponding to the first video sample, and the first masked video sample being obtained by performing masking for a predetermined area of the first object sample in the first video sample;
generating a predicted video based on the first predicted video feature representation; and
updating the video generation model based on at least a difference between the predicted video and the first video sample.

17. The electronic device of claim 16, wherein updating the video generation model comprises:
determining, by using a trained synchronization network, a time synchronization difference between the predicted video and the first audio sample; and
updating the video generation model based on the time synchronization difference.

18. The electronic device of claim 17, wherein determining the time synchronization difference between the predicted video and the first audio sample comprises:
extracting a second predicted video feature representation of the predicted video;
determining an audio feature representation of a first target audio sample; and
determining, by using the trained synchronization network, the time synchronization difference based on the second predicted video feature representation and the audio feature representation of the first target audio sample.

19. The electronic device of claim 17, wherein the synchronization network is trained by:
determining, by using a synchronization network to be trained, a time synchronization prediction result between a second video frame sample and a second audio sample based on a second training sample, the second training sample comprising a video feature representation of the second video frame sample and an audio feature representation of the second audio sample; and
training the synchronization network based on a difference between the time synchronization prediction result and a ground-truth time synchronization result labeled for the second training sample, the ground-truth time synchronization result indicating an audio-video synchronization degree between the second video frame sample and the second audio sample.

20. A non-transitory computer-readable storage medium having a computer program stored thereon, the computer program being executable by a processor to implement acts comprising:
obtaining a masked video by performing masking for a predetermined area of a target object in a reference video;
determining a first video feature representation of the reference video and a second video feature representation of the masked video, respectively;
determining an audio feature representation of target audio; and
generating, by using a trained video generation model, a target video containing the target object based on at least the first video feature representation, the second video feature representation and the audio feature representation, the target video representing the target object speaking the target audio with a mouth shape matching the target audio.
